(19) United States
(12) Patent Application Publication
(10) Pub. No.: US 2008/0118182 A1
(43) Pub. Date: May 22, 2008

(54) Method of Fusing Digital Images

(75) Inventor: Michel Koole, Gentbrugge (BE)

Correspondence Address: HOUSTON ELISEEVA, 4 MILITIA DRIVE, SUITE 4, LEXINGTON, MA, 02421, US

(73) Assignee: AGFA HEALTHCARE NV, Mortsel (BE)

(21) Appl. No.: 11/876,472

(22) Filed: Oct. 22, 2007

Related U.S. Application Data
(60) Provisional application No. 60/867,094, filed on Nov. 22, 2006.

(30) Foreign Application Priority Data
Nov. 20, 2006 (EP) 06124365.5

(51) Int. Cl. G06K 9/36

(52) U.S. Cl. 382/284

(57) ABSTRACT

A method of fusing two volume representations wherein the fused information is created by blending the information of datasets corresponding with the volume representations by means of a blending function with a blending weight that is adjusted locally and/or dynamically on the basis of the information of either of the datasets.

### RELATED APPLICATIONS

This application claims priority to European Patent Application No. EP 06124365.5, filed on Nov. 20, 2006, and claims the benefit under 35 USC 119(e) of U.S. Provisional Application No. 60/867,094, filed on Nov. 22, 2006, both of which are incorporated herein by reference in their entirety.

### BACKGROUND OF THE INVENTION

Fusion of at least two digital images of an object uses the first image which favors a particular constituent of the object, while the second favors another.

Such a technique has a particular important application in the medical field in which a first image of a body organ obtained by CT (Computerized Tomography) is fused with a second image of the same organ obtained by magnetic resonance imaging (MRI). In fact, the CT image particularly reveals the bony part. In such an image the bony part is white and all other parts, especially the soft tissues are a homogeneous gray without contrast. On the other hand, the MRI Image reveals soft tissues in different shades of gray levels and the other parts like the bony structure and empty space are black.

Another example where it is often desirable to combine medical images is fusion between positron emission tomography (PET) and computed tomography (CT) volumes. The PET measures the functional aspect of the examination, typically the amount of metabolic activity. The CT indicates the X-ray absorption of the underlying tissue and therefore shows the anatomic structure of the patient. The PET typically looks somewhat like a noisy and low-resolution version of the CT. However what the user is usually most interested in seeing the high intensity values from the PET and seeing where these are located within the underlying anatomical structure that is clearly visible in the CT.

In general, in the medical field, two two-dimensional digital images from different types of image acquisition devices (e.g. scanner types) are combined into a new composite image using the following typical approaches in fusion:

Checker board pattern: The composite image is divided into sub-regions, usually rectangles. If one sub-region is taken from one dataset, the next sub-region is taken from the other dataset, and so on. By looking at the boundaries between the sub-regions, the user can evaluate the accuracy of the match.

Image blending: Each pixel in the composite image is created as a weighted sum of the pixels from the individual images. The user evaluates the registration by varying the weights and seeing how the features shift when going from only the first image to viewing the blended image, to viewing only the second image.

Pixel Replacement: The composite image is initially a copy of one of the input images. A set of possibly non-contiguous pixels is selected from the other image and inserted into the composite image. Typically the selection of the set of replacement pixels is done using intensity thresholding. The user evaluates the registration by varying the threshold.

When the datasets represent three-dimensional volumes, the typical approaches to visualization are MPR-MPR (Multi-Planar Reformat) fusion which involves taking a MPR-plane through one volume and the corresponding plane through the other volume and using one of the two-dimensional methods described above.

Another approach involves a projector for creating a projection of both volumes (MIP—Maximum intensity projection, MinIP—Minimum Intensity projection) and again using one of the two-dimensional methods described above to create a composite image.

A major drawback of the previously described composite techniques is the fact that the techniques are an “all or nothing” approach.

For the checker board pattern, all pixels in a certain sub-region are taken from one of the two datasets, neglecting the pixel information in the other dataset. The same remark is valid for pixel replacement. While image blending tries to incorporate pixel information of both datasets, all pixels in the composite image are created however using the same weight for the whole dataset.

Still other approaches have been described in the literature. In ‘Multi-modal Volume Visualization using Object-Oriented Methods’ by Zuiderveld and Viergever, Proceedings Symposium on Volume Visualization, Oct. 17, 1994; an object-oriented architecture aimed at integrated visualization of volumetric datasets from different modalities is described. The rendering of an individual image is based on tissue specific shading pipelines.

In ‘Visualizing inner structures in multimodal volume data” by Manssour I H et al., Computer Graphics and Image Processing, 2002 fusion of two data sets from multimodal volumes for simultaneous display of the two data sets is described.

In European patent application EP 1 489 591 a system and method for processing images utilizing varied feature class weights is provided. A computer system associates two or more image with a set of feature class data such as color and texture data. The computer assigns a set of processing weights for each of the feature classes. The two or more images are blended according to the feature class weights. For example pixel display attributes are expressed in an Lab color model. The weights applied to each of the L, a, and b components (also called channel) may be different. The individual weights may be pre-assigned or according to the content being rendered. The weights are identical for each value within a channel.

### SUMMARY OF THE INVENTION

Given the importance of providing useful visualization information, it would be desirable and highly advantageous to provide a new technique for visualization of a volume-volume fusion that overcomes the drawbacks of the prior art.

The present invention relates to medical imaging. More particularly the present invention relates to fusion of medical digital images and to visualization of volume-volume fusion.

According to the present invention image representations are blended by using a blending function with a blending weight. This blending weight is determined locally and dynamically in dependence on the local image information in a data set of at least one of the images that are blended. The blended image can then be visualized on a display device such as a monitor.

The blending weight can be adapted locally and/or dynamically based on the information present in the datasets of the images. This information may comprise:
raw voxel or pixel values of the datasets,
processed voxel or pixel values of the datasets,
segmentation masks of the datasets,
extracted features from the datasets.

Pixel/voxel values can for example be filtered with a low pass filter to reduce the influence of noise on the blending weights.

Segmentation masks can for example be generated interactively by means of region growing, selecting a seed point and a range of pixel values. However, automatic segmentation techniques can also be used.

The curvature or gradient present (extracted features) in a pixel/voxel is in a specific embodiment used to determine the blending weight locally.

In a specific embodiment a so-called reformatter can be used. The function of the reformatter is to create corresponding planes through the volume representations of either of the images.

A blended plane is then provided according to this invention by blending corresponding plane using a blending function with locally and/or dynamically blended weights.

In another specific embodiment a projector can be used. The function of the projector is to create corresponding projections (MIP, Min-IP) of both volume representations of either of the images.

A blended projection is then provided according to this invention by blending corresponding plane using a blending function with locally and/or dynamically blended weights.

In still an alternative embodiment a volume renderer is used to compose a rendered blended volume using a locally and/or dynamically adjusted weight function.

Pixels/voxels may be weighted differently during blending according to their values in one of or both the datasets.

The blending weight may dependent on the voxel/pixel values by means of given thresholds.

For example, only pixels/voxels with values within or outside a given range are blended.

The method of the present invention can be implemented as a computer program product adapted to carry out the steps of any of the method.

The computer executable program code adapted to carry out the steps of the method is commonly stored on a computer readable medium such as a CD-ROM or DVD or the like.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 (a) is a CT image with clear demarcation of the bone of the skull;

FIG. 1 (b) is a MR image with clear rendering of the brain tissue;

FIG. 1 (c) is a coronally fused image;

FIG. 1 (d) is an axial image wherein the bone structure of the CT image is superposed on the MR image by means of the ‘smart blending’ method of the present invention; and

FIG. 2 is a flow diagram illustrating an embodiment of the present invention.

### DETAILED DESCRIPTION OF THE PREFERRED EMBODIMENTS

The present invention provides a technique for combining various types of diagnostic images to allow the user to view more useful information for diagnosis. It can be used for fused visualization of two-dimensional diagnostic images or three-dimensional volumes. For the visualization of volume-volume fusion, it can be combined with the reformatting approach (MPR), projection approach (MIP-MinIP) or Volume Rendering (VR).

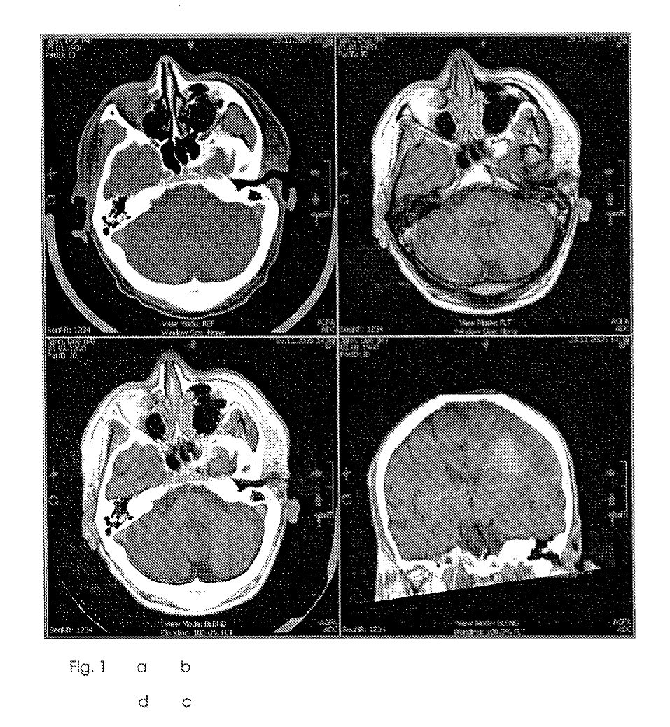

FIGS. 1(a)-1(d) show the blending process.

For example FIG. 1(a) is a CT image representation. As is typical with this imaging modality, there is a clear demarcation of the bone of the skull.

FIG. 1(b) is a MR image representation. This MR image provides a clear rendering of the brain tissue.

FIG. 1(c) shows a resulting coronally fused image. In contrast, FIG. 1 (d) is an axial image in which the bone structure of the CT image is superposed on the MR image by means of the ‘smart blending’ according to an embodiment of the present invention, in which blending weight is determined locally and dynamically in dependence on the local image information in a data set of at least one of the images that are blended.

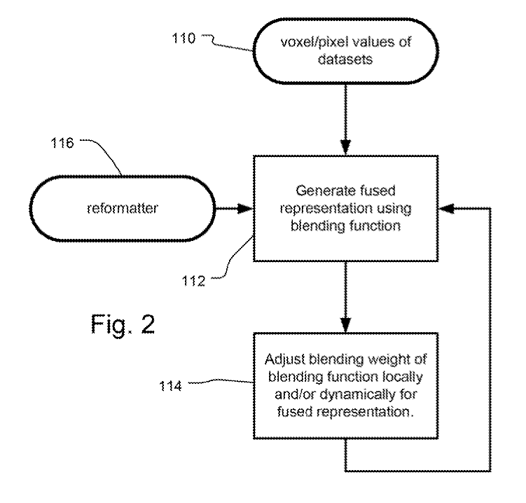

FIG. 2 shows a method for image blending according to the principles of the present invention.

The method starts with the voxel and/or pixel values 110 of representations for two or more data sets, usually produced by different imaging modalities.

The voxel and/or pixel values 110 of the representations are blended by using a blending function with a blending weight in step 112. This blending weight is determined locally and dynamically in dependence on the local image information in a data set of at least one of the images that are blended in step 114. This process of blending and adjusting the blending function weight is repeated across the blended image.

The blended image can then be visualized on a display device such as a monitor.

The blending weight is adapted locally and/or dynamically based on the information present in the datasets of the images. This information usually comprises one or more of the following:
raw voxel or pixel values of the datasets,
processed voxel or pixel values of the datasets,
segmentation masks of the datasets,
extracted features from the datasets.

Pixel/voxel values are, for example, filtered with a low pass filter to reduce the influence of noise on the blending weights.

Segmentation masks can for example be generated interactively by means of region growing, selecting a seed point and a range of pixel values. However, automatic segmentation techniques can also be used.

The curvature or gradient present (extracted features) in a pixel/voxel is in a specific embodiment used to determine the blending weight locally.

In a specific embodiment a so-called reformatter 116 is used. The function of the reformatter is to create corresponding planes through the volume representations of either of the images.

A blended plane is then provided according to this invention by blending corresponding plane using a blending function with locally and/or dynamically blended weights.

In another specific embodiment a projector can be used. The function of the projector is to create corresponding projections (MIP, Min-IP) of both volume representations of either of the images.

A blended projection is then provided according to this invention by blending corresponding plane using a blending function with locally and/or dynamically blended weights.

In still an alternative embodiment a volume renderer is used to compose a rendered blended volume using a locally and/or dynamically adjusted weight function.

Pixels/voxels may be weighted differently during blending according to their values in one of or both the datasets.

The blending weight may dependent on the voxel/pixel values by means of given thresholds.

For example, only pixels/voxels with values within or outside a given range are blended.

In one embodiment the blending weight is 0 (never present in the blended image) for pixels/voxels with values within a given range for the dataset pertaining to one image and a given range for the other dataset.

For example, the blending weight is 1 (always present in the blended image) for pixels/voxels with values within the given range for one dataset and within the given range for the other dataset.

A blending function for each pixel/voxel i is, in one example

bᵢ=α·v₁ᵢ·c₁ᵢ+(1−α)·v₂ᵢ·c₂ᵢ

where bᵢ is the value of the blended pixel/voxel, v₁ᵢ and v₂ᵢ are the pixel/voxel values in respectively volume 1 and 2, and α is the blending factor.

c₁ᵢ is 1 if v₁ᵢ is inside a specified range min₁≦v₁ᵢ≦max, and 0 otherwise.

c₂ᵢ is 1 if V₂₁ is inside a specified range min₂≦v₂1≦max₂ and 0 otherwise.

A variant of the blending mentioned above, is the following:

bᵢ=α·v₁ᵢ·C₁ᵢ+(1−α)·v₂ᵢ·c₂ᵢ+(1−c₁ᵢ)·z₁+(1−C₂ᵢ)·z₂

where z₁ and Z₂ are the values that should be given to pixels/voxels i when its value is outside the given range.

In an alternative embodiment the blending weight is dependent of segmentation masks determined for both datasets.

For example, the blending weight is set to zero for pixels/voxels that belong to a given segmentation mask created for one of the datasets.

The blending weight can also be set to 1 for pixels/voxels that belong to a given segmentation mask created for one of the datasets.

The weighting function is edited manually in one example.

However, the preferred embodiment of the present invention does not use a global weight factor of the original pixel intensities to obtain the pixel values of the composite image. Instead, it uses a weighting function and information in the datasets of the images that are fused to determine the weight factor locally and dynamically.

In one embodiment of the invention the weighting function for blending a CT image with a MRI image is set in such a way that for pixel values of the CT image that correspond with bony structure the weight factor is always 1. When going from only the CT image to viewing the blended CT-MRI image the bony structures present in the CT image remain present in the composite blended image.

In another embodiment of the invention the weighting function for blending a CT image with a PET image can be set in such a way that PET pixel values within the range corresponding to the pathology have of a weight factor of 1. When going from only the CT image to viewing the blended CT-PET image only the pathological PET information will appear and remain present in the composite blended CT/PET image.

It is to be understood that the present invention may be implemented in various forms of hardware, software, firmware, special purpose processors or a combination thereof. Preferably, the present invention is implemented in software as a program tangibly embodied on a program storage device. The program is uploaded to, and executed by a machine comprising any suitable architecture. Preferably the machine is implemented on a computer platform having hardware such as one or more central processing units (CPU), a random access memory (RAM), a graphical processing unit (GPU) and input/output (I/O) interface(s). The computer platform also includes an operating system and microinstruction code. The various processes and functions described herein may either be part of the microinstruction code or part of the program (or combination thereof) which is executed via the operating system. In addition, various other peripheral devices may be connected to the computer platform such as an additional storage device or a printing device.

The computer may be a stand-alone workstation or be linked to the network via a network interface. The network interface may be linked to various types of networks including Local Area Network (LAN), a Wide Area Network (WAN) an intranet, a virtual private network (VPN) and the internet.

Although the examples mentioned in connection with the present invention involve combinations of 3D volumes, it should be appreciated that 4-dimensional (4D) or higher dimensional data could also be used without departing from the spirit and scope of the present invention.

As discussed, this invention is preferably implemented using general purpose computer systems. However the systems and methods of this invention can be implemented using any combination of one or more programmed general purpose computers, programmed micro-processors or micro-controllers, Graphics Processing Units (GPU) and peripheral integrated circuit elements or other integrated circuits, digital signal processors, hardwired electronic or logic circuits such as discrete element circuits, programmable logic devices or the like.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of fusing at least two volume representations, comprising:
generating a fused representation by blending the information of datasets corresponding with said volume representations using a blending function with a blending weight; and
adjusting the blending weight locally and/or dynamically on the basis of said information of either of said datasets.

2. A method according to claim 1 wherein said information comprises raw voxel/pixel values of said datasets.

3. A method according to claim 1 wherein said information of said data sets comprises processed voxel/pixel values of said datasets.

4. A method according to claim 1 wherein said information of said data sets comprises segmentation masks of said datasets.

5. A method according to claim 4 where the blending weight is set to zero for pixels/voxels that belong to a given segmentation mask created for one of the datasets.

6. A method according to claim 4 where the blending weight is set to 1 for pixels/voxels that belong to a given segmentation mask created for one of the datasets.

7. A method according to claim 1 wherein said information of said data sets pertains to extracted features from said datasets.

8. A method according to claim 1, further comprising using a reformatter to create corresponding planes through both volumes and where a blended plane uses a locally and/or dynamically adjusted weight function.

9. A method according to claim 1, further comprising using a projector to create corresponding projections of both volumes and where a blended projection uses a locally and/or dynamically adjusted weight function.

10. A method according to claim 1, further comprising using a volume renderer to generate a rendered blended volume using a locally and/or dynamically adjusted weight function.

11. A method according to claim 1, wherein the blending weight is dependent on the voxel/pixel values by means of given thresholds.

12. A method according to claim 1, wherein the blending weight is 0 (never present in the blended image) for pixels/voxels with values within the given range for one dataset and within the given range for the other dataset.

13. A method according to claim 1, wherein the blending weight is 1 for pixels/voxels with values within a given range for a first dataset and within a given range for a second dataset.

14. A method according to claim 1, further comprising editing the weighting function manually.

15. A computer software product for fusing at least two volume representations, the product comprising a computer-readable medium in which program instructions are stored, which instructions, when read by a computer, cause the computer to:
generate a fused representation by blending the information of datasets corresponding with said volume representations using a blending function with a blending weight; and
adjust the blending weight locally and/or dynamically on the basis of said information of either of said datasets.

16. A computer software program for fusing at least two volume representations, the program, when executed by a computer, causes the computer to:
generate a fused representation by blending the information of datasets corresponding with said volume representations using a blending function with a blending weight; and
adjust the blending weight locally and/or dynamically on the basis of said information of either of said datasets.
